(19) United States
(12) Patent Application Publication
(10) Pub. No.: US 2025/0192622 A1
(43) Pub. Date: Jun. 12, 2025

(54) STATOR CORE OF ROTARY ELECTRIC MACHINE

(71) Applicant: DENSO CORPORATION, Kariya-city (JP)

(72) Inventors: KEIJI KONDO, Kariya-city (JP); TOMOKAZU HISADA, Kariya-city (JP); HIROSHI ENDO, Kariya-city (JP)

(21) Appl. No.: 18/968,671

(22) Filed: Dec. 4, 2024

(30) Foreign Application Priority Data
Dec. 6, 2023 (JP) 2023-205923

(51) Int. Cl. H02K 1/16

(52) U.S. Cl. CPC H02K 1/165

(57) ABSTRACT

A stator core for a rotary electric machine includes a stator core with a circular back yoke and teeth protruding from the back yoke in a radial direction of the stator core. The stator core is formed by stacking core sheets in multiple layers. Each core sheet has convex portions provided at predetermined intervals in a circumferential direction, and flat portions provided between adjacent convex portions in the circumferential direction. Each convex portion has a folded shape that is convex in a stacking direction and extends in the radial direction. The convex portions are stacked and overlap each other in the stacking direction. A plate thickness of the convex portion is smaller than a plate thickness of the flat portion.

### CROSS REFERENCE TO RELATED APPLICATION

The present application is based on Japanese Patent Application No. 2023-205923 filed on Dec. 6, 2023, the entire disclosure of which is incorporated herein by reference.

### TECHNICAL FIELD

This invention relates to a stator core of a rotary electric machine.

### BACKGROUND

Conventionally, a stator core of a rotary electric machine has a multilayer stacked configuration of core sheets made of steel plate material.

### SUMMARY

According to at least one embodiment, a stator core for a rotary electric machine includes a stator core with a circular back yoke and teeth protruding from the back yoke in a radial direction of the stator core. The stator core is formed by stacking core sheets in multiple layers. Each core sheet has convex portions provided at predetermined intervals in a circumferential direction, and flat portions provided between adjacent convex portions in the circumferential direction. Each convex portion has a folded shape that is convex in a stacking direction and extends in the radial direction. The convex portions are stacked and overlap each other in the stacking direction. A plate thickness of the convex portion is smaller than a plate thickness of the flat portion.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a perspective view of a stator.

FIG. 2 is a front view of the stator.

FIG. 3 is a plan view of the stator core.

FIG. 4A is an enlarged diagram illustrating a plan view of a portion of a core sheet.

FIG. 4B is an enlarged diagram illustrating a cross-sectional view of a portion of a core sheet.

FIG. 5 is a diagram illustrating manufacturing process of the stator core.

FIG. 6A is a cross-sectional view of the core sheet.

FIG. 6B is a cross-sectional view of the core sheet in a core sheet stacked state.

FIG. 6C is a cross-sectional view of the core sheet from an outside of a yoke forming portion 31 in a radial direction.

FIG. 7A is a diagram illustrating a pain view of the core sheet.

FIG. 7B is a diagram illustrating a side view of the core sheet.

FIG. 8 is a diagram illustrating the core sheet.

FIG. 9 is a diagram illustrating a core sheet of a first modification.

FIG. 10 is a diagram illustrating a core sheet of the first modification.

FIG. 11 is a cross-sectional view illustrating a state in which a stator winding is assembled with the stator core of the first modification.

FIG. 12 is a cross-sectional view illustrating a state in which a stator winding is assembled with a stator core of a second modification.

FIG. 13 is a diagram illustrating a core sheet of the second modification.

FIG. 14A is a diagram illustrating an inner shape of a core sheet of a third modification.

FIG. 14B is a diagram illustrating an outer shape of a core sheet of a third modification.

FIG. 15A is a diagram illustrating a first sheet of a second embodiment.

FIG. 15B is a diagram illustrating a second sheet of a second embodiment.

FIG. 16A is a diagram illustrating the core sheet of the second embodiment.

FIG. 16B is a diagram illustrating the core sheet of the second embodiment in a first and second sheet stacked state.

FIG. 16C is a diagram illustrating the core sheet of the second embodiment in a multiple layer stacked state.

FIG. 17 is a diagram illustrating another example of a core sheet.

### DETAILED DESCRIPTION

To begin with, examples of relevant techniques will be described.

Conventionally, a stator core of a rotary electric machine has a multilayer stacked configuration of core sheets made of steel plate material. In addition, a stator core according to a comparative example is known in which folded portions having a triangular mountain shape are formed at predetermined intervals in a circumferential direction on a strip-shaped core sheet during manufacture of a stator core, and the core sheet is curved by these folded portions.

However, in a configuration in which a core sheet has folded portions having a triangular mountain shape and the folded portions are stacked, a thickness in the stator core becomes locally thicker in a stacking direction because the steel sheet material in the folded portions is inclined to the stacking direction. As a result, gaps are unintentionally created in the stator core at points other than the folded portions. In this case, there is concern that the stator core may not be strong enough in a configuration where the core sheet is fixed by caulking, welding, or other means, or that this may result in reduced performance of a rotary electric machine.

In contrast to the comparative example, according to a stator core of a rotary electric machine of the present disclosure, a formation of unintended gaps between core sheets in a stacked state can be reduced.

According to one aspect of the present disclosure, a stator core for a rotary electric machine includes a stator core with a circular back yoke and teeth protruding from the back yoke in a radial direction of the stator core. The stator core is formed by stacking core sheets in multiple layers. Each core sheet has convex portions provided at predetermined intervals in a circumferential direction, and flat portions provided between adjacent convex portions in the circumferential direction. Each convex portion has a folded shape that is convex in a stacking direction and extends in the radial direction. The convex portions are stacked and overlap each other in the stacking direction. A plate thickness of the convex portion is smaller than a plate thickness of the flat portion.

According to this configuration, in the stator core including of multilayered stacked core sheets, the core sheets have the convex portions in a bent shape convex in the stacking direction and extending in the radial direction at the predetermined intervals in the circumferential direction, and the core sheets are stacked with the convex portions overlapping each other in the stacking direction. In this case, the convex portion causes the core sheet to curve into an arc, suitably forming the circular back yoke. In the core sheet, the plate thickness of the convex portion and the flat portion, which is an area between adjacent convex portions in the circumferential direction, are different, and the plate thickness of the convex portion is smaller than that of the flat portion. As a result, when steel plate material is inclined to the stacking direction (i.e., stator axial direction) in the convex portion, a difference in thickness of the steel plate material between the convex and flat portions in the stacking direction becomes small. As a result, inadvertent gaps between core sheets in the stacked stator core are prevented, reducing problems such as insufficient stator core strength.

### First Embodiment

Hereinafter, an embodiment of a stator of a rotary electric machine mounted on a hybrid vehicle or an electric vehicle will be described below with reference to the drawings. In the following embodiments and modifications, the same or equivalent parts will be denoted by the same reference numbers in the drawings, and explanation thereof in detail will be omitted. A rotary electric machine is, for example, an electric motor, a generator, or a motor generator (MG).

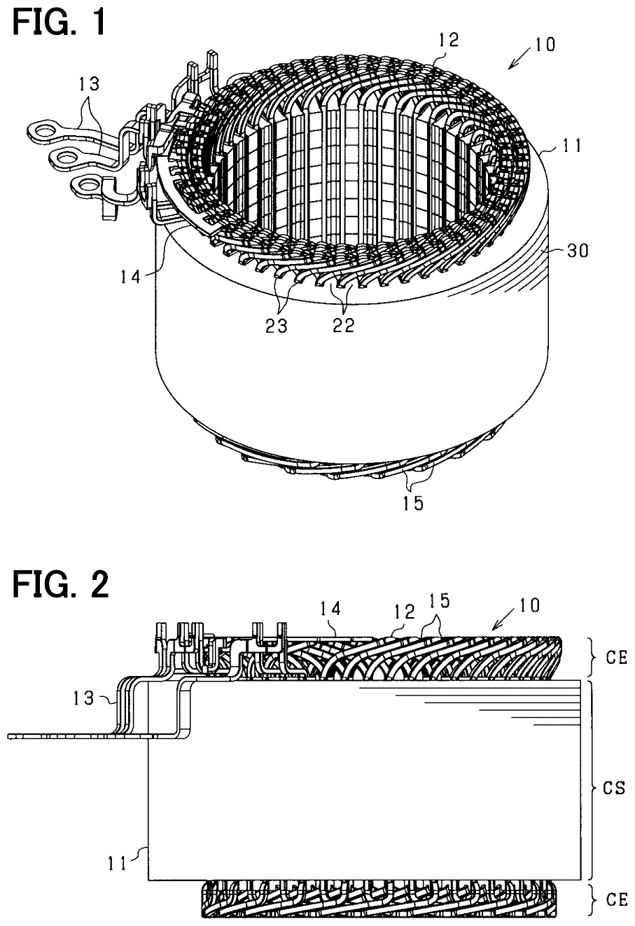

The rotary electric machine of the present embodiment is applicable to permanent magnet synchronous motors as well as wound field magnet type and induction machines, and has three-phase windings. The rotary electric machine includes a cylindrical stator 10, shown in FIG. 1, and a rotor (not shown), which is located on an inner side of the stator 10 in a radial direction. The rotor is rotatable about a rotation axis relative to the stator 10. Hereinafter, an axial direction refers to an axial direction of the stator 10, that is, the axial direction of the rotation axis of the rotor; a radial direction refers to the radial direction of the stator 10, that is, a direction passing through a center of the rotation axis of the rotor and orthogonal to the rotation axis; and a circumferential direction refers to a circumferential direction of the stator 10, that is, the circumferential direction around the rotation axis of the rotor.

As shown in FIGS. 1 and 2, the stator 10 includes a stator core 11 having an annular shape and a multiphase stator winding 12 wound around the stator core 11. The rotary electric machine of the present embodiment is an inner-rotor type, and the rotor is arranged to be rotatable on the inner side of the stator 10 in the radial direction. The stator winding 12 has a 3-phase winding with a U-phase winding, a V-phase winding, and a W-phase winding as phase windings for each phase, and a power line busbar 13 is connected to one of ends and a neutral line busbar 14 is connected to the other one of ends of the phase windings of each phase. In the stator winding 12, an area overlapping the stator core 11 in the axial direction is a coil side CS, and a portion on both sides in the axial direction that is outside the stator core 11 in the axial direction is a coil end CE.

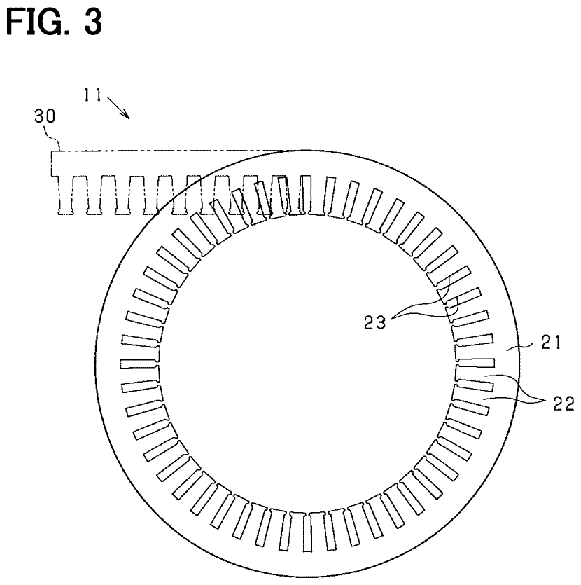

FIG. 3 is a plan view of the stator core 11. The stator core 11 is composed of core sheets 30 made of steel plate material (electromagnetic steel sheet), stacked in multiple layers in the axial direction and fixed by caulking, welding, bonding, or other means. In the present embodiment, the stator core 11 is a helical stator core structure consisting of strip-shaped core sheets 30 stacked in a spiral shape. Since the stator core 11 is the helical stator core structure, material yield, material saving, and cost reduction can be improved.

The stator core 11 includes a back yoke 21 in an annular shape and teeth 22 which protrudes radially inward from the back yoke 21 and are arranged at a predetermined distance in the circumferential direction, and is formed with slots 23 between adjacent teeth 22. The slots 23 have an opening shape extending in the radial direction as a longitudinal direction, and are provided at equal intervals in the circumferential direction in the stator core 11. The slots 23 are open radially inward of the stator core 11.

As shown in FIG. 1, each of the 23 slots is wound with the stator winding 12 at a predetermined slot pitch. The stator winding 12 is configured in a state using, for example, an insulated conductive wire in which a conductor is covered with an insulating layer, wherein which conductive wires are accommodated in the slots 23 in multiple layers in the radial direction. In the present embodiment, the stator winding 12 has a segmented structure with conductor segments 15 having an abbreviated U-shape and being joined together to form the stator winding 12. In the stator winding 12, the coil end CE on one side of the axial direction is formed by turn portions of each conductor segment 15, and the coil end CE on the other side of the axial direction is formed by connecting the ends (straight portions) of the different conductor segments 15 with each other. The stator winding 12 generates magnetic flux when electric power is supplied to each phase via an inverter (not shown).

In the present embodiment, a core sheet 30 of the core sheets has convex portions 34 that have a folded shape that is convex in the stacking direction. The convex portions have a shape that extends in the radial direction. The convex portions 34 are provided at predetermined intervals in the circumferential direction. This causes the core sheet 30 to be bent into an arcuate shape. The details will be described below.

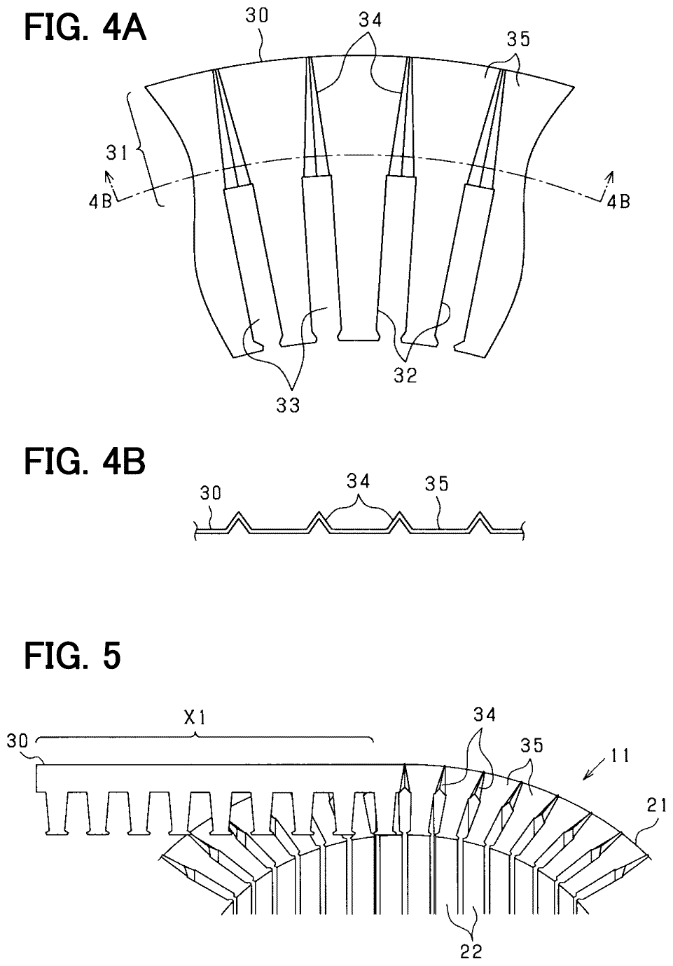

FIG. 4A shows an enlarged view of a portion of the core sheet 30. FIG. 4A is a plan view of the core sheet 30, and FIG. 4B is a cross-sectional view in a 4B-4B line section of FIG. 4A. As shown in FIG. 4A, the core sheet 30 has, roughly speaking, a long strip-shaped yoke forming portion 31, which is a portion forming the back yoke 21, and a teeth forming portion 32, which is a portion forming the teeth 22. The back yoke 21 is formed by stacking the core sheet 30 so that the yoke forming portion 31 overlap in the axial direction. The teeth 22 are formed by overlapping the teeth forming portion 32 in the axial direction. In other words, in the stator core 11, a portion of the core sheet 30 corresponding to the yoke forming portion 31 is the back yoke 21 and a portion corresponding to the teeth forming portion 32 is the teeth 22. In the core sheet 30, a space between the circumferentially aligned teeth forming portions 32 is a slot recess 33 for slot formation.

The yoke forming portion 31 has a convex portion 34 that is bent convex in the stacking direction and extends in the radial direction. The convex portion 34 has a larger protruding height on an inner side of the radial direction and a smaller protruding height on an outer side of the radial direction in the yoke forming portion 31, and is triangular in plan view with a narrower width on the outer side of the radial direction. The convex portion 34 is provided at a position that is radially outside of each slot recess 33. As a result, the convex portion 34 is provided at predetermined intervals in the circumferential direction (see FIG. 4B). In the yoke forming portion 31, a portion between adjacent convex portions 34 in the circumferential direction is a flat portion 35. The flat portion 35 of the yoke forming portion 31 and the teeth forming portion 32 are both flat and continuous in the radial direction.

Since the yoke forming portion 31 has the convex portions 34 at predetermined intervals, a circumferential length of an inner portion in the radial direction of the yoke forming portion 31 is shorter than a circumferential length of an outer portion in the radial direction in plan view, and the core sheet 30 is curved into an abbreviated arc shape. In the stator core 11, when the core sheet 30 is stacked in multiple layers, the convex portions 34 and flat portions 35 overlap each other in the stacking direction. In this case, a concave side of the convex portion 34 is an inner convex portion 36, the core sheet 30 is laminated so that the convex portion 34 of a lower layer is inserted into the inner convex portion 36 of the convex portion 34 of an upper layer.

FIG. 5 is a diagram illustrating manufacturing process of the stator core 11. In FIG. 5, an area indicated by “X1” shows the core sheet 30 before it is spirally curved, and an area beyond “X1” shows the core sheet 30 after it is spirally curved.

Before being formed into a curve, the core sheet 30 is formed into a flat predetermined shape by pressing, for example, steel sheet material. The yoke forming portion 31 has a straight strip shape, and from the yoke forming portion 31, the teeth forming portions 32 are formed at predetermined intervals so as to extend orthogonally to the longitudinal direction of the yoke forming portion 31. In the pre-curvature stage, opposing portions of the slot recess 33 that face each other in the longitudinal direction of the yoke have an abbreviated V-shape that widens toward the tip of the teeth.

Then, using a bending device (not shown), the cylindrical stator core 11 is formed while the core sheet 30 is spirally bent by bending the yoke forming portion 31. In other words, the core sheet 30 is curved into an abbreviated arc shape by bending and forming the convex portions 34 at predetermined intervals on the yoke forming portion 31. The convex portion 34 is formed so that an inner portion in the radial direction is wider and an outer portion in the radial direction is narrower in plan view, so that a circumferential length of the inner portion in the radial direction is different from a circumferential length of the outer portion in the radial direction and the core sheet 30 is curved into an abbreviated arc shape. After forming the curvature, opposing portions facing each other in the longitudinal direction of the yoke in the slot recess 33 are parallel to each other.

The spirally formed core sheets 30 are stacked in multiple layers with the convex portions 34 overlapping each other in the stacking direction. As a result, the cylindrical stator core 11 is formed. Then, the flat portion 35 is fixed axially in the stator core 11 by caulking, welding, gluing, or other means.

By the way, in a configuration where the core sheet 30 has the convex portions 34, when a plate thickness of the steel sheet material are the same in the convex portion 34 and the flat portion 35, a plate thickness in the stacking direction (i.e., stator axial direction) in the convex portion 34 is thicker than that in the flat portion 35. Therefore, there is concern that gaps may be created between the flat portions 35 in the stacked state of the core sheet 30, resulting in insufficient strength of the stator core 11 and reduced performance of the rotary electric machine.

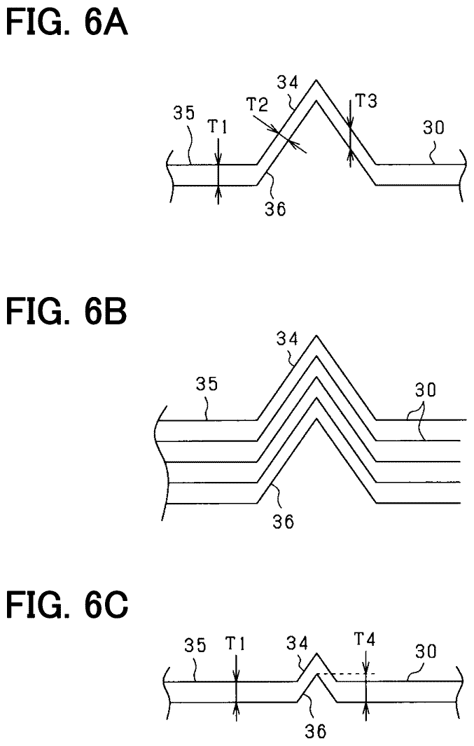

Therefore, in the present embodiment, a plate thickness of the convex portion 34 is different from a plate thickness of the flat portion 35 in the core sheet 30, and the configuration is shown in FIG. 6A. In FIG. 6A, the plate thickness of the flat portion 35 is “T1” and that of the convex portion 34 is “T2”, and the relationship between these T1 and T2 is T1>T2. The plate thicknesses T1, T2 are equivalent to a wall thickness in a direction perpendicular to a plate surface in the steel sheet material comprising the core sheet 30.

In this case, the plate thickness T2 of the convex portion 34 is smaller than the plate thickness T1 of the flat portion 35. As a result, in the core sheet stacked state shown in FIG. 6B, formation of a gap between the flat portions 35 is reduced and each flat portion 35 is in contact with each other. It is desirable to make a thickness T3 of the convex portion 34 in the stacking direction the same as the plate thickness T1 of the flat portion 35 (i.e., T1=T3). In such a case, the flat portions 35 can be in contact with each other in the stacking direction and the convex portions 34 can be in contact with each other.

A relationship between the plate thickness T1 of the flat portion 35 and the thickness T3 of the convex portion 34 in the stacking direction may be T1>T3, in addition to T1=T3. Even with this configuration, the formation of gaps between the flat portions 35 in the stacked state of the core sheet 30 is reduced.

In the present embodiment, the convex portion 34 is provided in the yoke forming portion 31 from an inner end portion to an outer end portion in the radial direction, that is, in the entire radial direction of the yoke forming portion 31, and is formed to protrude from the flat portion 35 in the entire radial direction of the yoke forming portion 31. In other words, the convex portion 34 is formed so that the convex portion 34 protrudes from the flat portion 35 even at the outer end portion of the yoke forming portion 31 in the radial direction, that is, a portion where a protruding height of the convex portion 34 is the smallest.

Here, in the core sheet 30, when the protrusion height of the convex portion 34 is zero at the outer end portion of the yoke forming portion 31 in the radial direction, the convex portion 34 protrudes axially from the zero protrusion height in the radial direction, a direction in which the convex portion 34 extends. In this case, at an initial portion of the convex portion 34, it becomes difficult to bend and shape the steel sheet material and thin it to form the convex portion 34. Regarding this, as described above, the convex portion 34 is formed so that the convex portion 34 protrudes from the flat portion 35 even at the outer end portion of the yoke forming portion 31 in the radial direction, that is, the portion where the protruding height of the convex portion 34 is minimum, which facilitates bending and forming the steel plate material and thinning it to form the convex portion 34.

FIG. 6C shows a side view of the core sheet 30 viewed from an outside of the yoke forming portion 31 in the radial direction. As shown in FIG. 6C, at the outer end position of the convex portion 34 in the radial direction, a depth T4 of the inner convex portion 36 is grater than the plate thickness T1 of the flat portion 35. The depth T4 of the inner convex portion 36 may be the same as the plate thickness T1 of the flat portion 35.

During manufacture of the stator core 11, when the convex portion 34 is formed on the core sheet 30 by the bending device and the core sheet 30 is bent, the convex portion 34 is bent and formed while the steel sheet material is thinned by pressure rolling, at a position to be formed of the convex portion 34 of the yoke forming portion 31. For example, a pressure device that clamps the core sheet 30 in a thickness direction of the core sheet 30 should be used, and a thickness of a thin-walled portion should be adjusted while the steel sheet material is thinned by a pressure of the pressure device. The bending machine may perform bending and thinning of steel sheet material as simultaneous processes, or it may perform bending and thinning of steel sheet material as separate processes, such as bending steel sheet material and then thinning it, or bending steel sheet material after thinning it. In short, the bending device should complete the bending and thinning of the steel sheet material prior to stacking the core sheets 30.

In the core sheet 30 of the present embodiment, it is recommended that a pre-bending area be defined in the steel sheet material before folding, taking into account that thinning is performed in addition to folding of the steel sheet material. In other words, when the steel sheet material is thinned, longitudinal elongation occurs in the steel sheet material, so a range of the pre-bending area should be set smaller to account for this elongation.

By the way, when the core sheet 30 is bent by the convex portions 34 provided at predetermined intervals in the circumferential direction, the yoke forming portion 31 becomes polygonal, and the back yoke 21 is formed into a polygonal cylindrical shape by the polygonal yoke forming portion 31. In the rotary electric machine, the stator core 11 may be assembled in a fitted condition on the inner circumference of a cylindrical housing. In this case, the stator core 11 and the housing are in multi-point contact on an outer surface of the stator core 11, and there is concern that a mating pressure in the stator core 11 will be concentrated at a contact area with the housing, resulting in reduced fixing force due to deformation in a vicinity of the contact area. In addition, there is concern that high partial mating stresses applied to the stator core 11 may increase core iron loss due to residual stresses, resulting in lower motor efficiency.

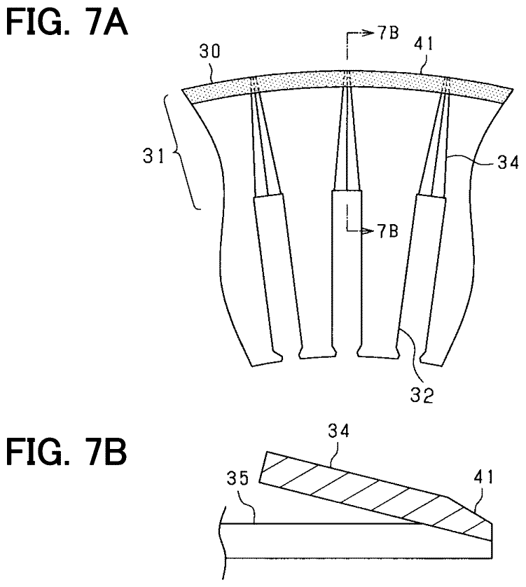

In the present embodiment, therefore, in the core sheet 30, the outer end portion of the yoke forming portion 31 in the radial direction (that is, a radial direction edge opposite to the teeth forming portion 32) is partially rolled and a portion that is between each convex portion 34 in the circumferential direction is formed to be circular in plan view. More specifically, as shown in FIGS. 7A, 7B, a rolled portion 41 extending circumferentially is provided at the outer end portion of the yoke forming portion 31. In this case, since the convex portion 34 is formed on the core sheet 30, the stator core 11 has an annular shape, while the partial rolling of the outer end portion of the yoke forming portion 31 prevents the outer surface of the stator core 11 from becoming polygonal in shape. In the present embodiment, the partial rolling is performed in the core sheet 30, so that the increase in the core iron loss due to rolling can be reduced.

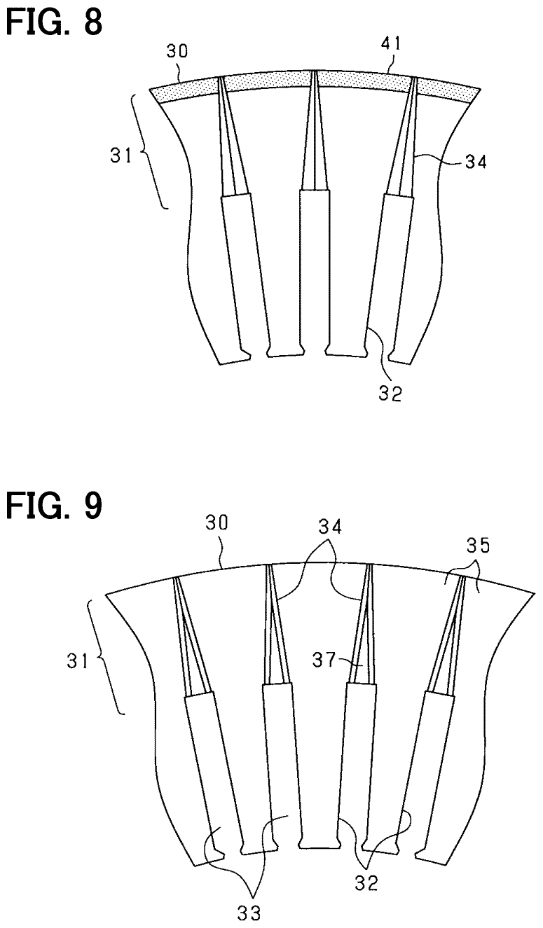

As shown in FIG. 8, the rolled portion 41 should be located at the outer edge portion of the back yoke 21, excluding the convex portion 34. In this case, since the rolled portion 41 is intermittently formed in the yoke forming portion 31 avoiding the convex portion 34, deformation of the outer edge portion caused by the flattening of the convex portion 34 can be reduced.

It is possible to obtain the following excellent effects according to the present embodiment described in detail.

In the core sheet 30, the plate thickness T2 of the convex portion 34 is different from the plate thickness T1 of the flat portion 35, and the plate thickness T2 of the convex portion 34 is smaller than the plate thickness T1 of the flat portion 35. As a result, even if the steel plate material is inclined to the stacking direction (the stator axial direction) at the convex portion 34, the difference in thickness of the steel plate material between the convex portion 34 and the flat portion 35 in the stacking direction becomes small. As a result, the formation of unintended gaps between the core sheets 30 in the stacked state in the stator core 11 can be reduced.

In this case, caulking, welding, and bonding between the core sheets 30 can be performed without issues, and the reduction in the strength of the stator core 11 can be reduced. In addition, the reduction in torque output due to the lower occupancy ratio of the magnetic material in the stator core 11 and the increase in body size due to gaps can be reduced. Furthermore, in the stator core 11, the core sheet 30 adheres closely in the stacking direction, which improves heat dissipation due to reduced thermal resistance, resulting in higher power output.

The convex portion 34 of the core sheet 30 is formed so that the convex portion 34 protrudes from the flat portion 35 in the yoke forming portion 31 with a larger protrusion height inside the radial direction and a smaller protrusion height outside the radial direction. The convex portion 34 also protrudes from the flat portion 35 even at the outermost radial portion of the yoke forming portion 31, which is a portion where the protruding height of the convex portion 34 is the smallest. In this case, compared to a configuration in which the protruding height of the convex portion 34 is zero at the outermost radial direction of the yoke forming portion 31 in the core sheet 30, it is easier to form the convex portion 34 by bending and forming the steel sheet material and making it thinner, and the convex portion 34 can be formed properly by thinning the steel sheet material.

At the outermost radial position of the convex portion 34, the depth T4 of the inner convex portion 36 is the same as or larger than the plate thickness T1 of the flat portion 35. This allows the core sheets 30 to be better joined together over the entire radial range of the yoke forming portion 31.

The rolled portion 41 is provided at the outer edge of the yoke forming portion 31 of the core sheet 30, and portions between each convex portion 34 in the circumferential direction are formed into a circular arc in plan view by the rolled portion 41. In this case, since the convex portion 34 is formed on the core sheet 30, the stator core 11 has an annular shape, while the partial rolling of the outer end portion of the yoke forming portion 31 prevents the outer surface of the stator core 11 from becoming polygonal in shape.

The rolled portion 41 may be provided at a portion excluding the convex portion 34 in the yoke forming portion 31 of the core sheet 30, whereby deformation of the outer edge of the yoke forming portion 31 caused by flattening of the convex portion 34 can be reduced.

Modifications of the first embodiment are shown below.

### First Modification

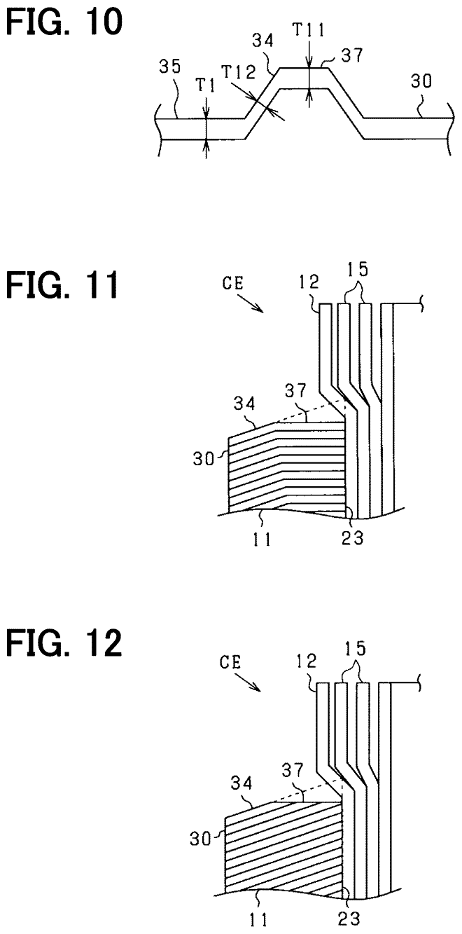

In a configuration shown in FIGS. 9, 10, a convex portion 34 is trapezoidal in shape, an upper base 37 of the convex portion is parallel to the flat portion 35. In this case, as shown in FIG. 9, the upper base 37 is formed by flattening a top in a certain range in the radial direction including the innermost edge (slot recess 33 side) in the radial direction in the convex portion 34.

As shown in FIG. 10, in the convex portion 34, a plate thickness T11 of the upper base 37 is larger than a plate thickness T12 of an inclined portion. The plate thickness T11 of the upper base 37 should be the same as the plate thickness T1 of the flat portion 35. However, the plate thickness T11 of the upper base 37 may be the same as the plate thickness T12 of the inclined portion, or it may be smaller than the plate thickness T1 of the flat portion 35.

FIG. 11 is a cross-sectional view of the stator core 11 with the stator winding 12 assembled. As shown in FIG. 11, the stator winding 12 is housed in a slot 23 of the stator core 11. The stator winding 12 consists of conductor segments 15 arranged in the radial direction. Each conductor segment 15 is positioned close to each other in the radial direction inside the slot 23 (coil side CS) and also is apart from each other in the radial direction outside the slot 23 (coil end CE). In this case, at the coil end CE, a conductor segment 15 (the stator winding 12) of the conductor segments is bent and formed radially outward, opposite a rotor air gap, so if the convex portion 34 protrudes axially in the stator core 11, interference between the convex portion 34 and the conductor segment 15 is a concern. Regarding this, as described above, the convex portion 34 is formed in the trapezoidal shape, with a top portion being the upper base 37, so that interference between the convex portion 34 and the conductor segment 15 can be reduced.

In addition, by making the convex portion 34 trapezoidal, a coil end height of the stator winding 12 can be reduced, enabling downsizing of the rotary electric machine, and a magnetic path length of the convex portion 34 is shorter than that of a triangular convex portion 34, resulting in higher torque output by reducing magnetic resistance.

### Second Modification

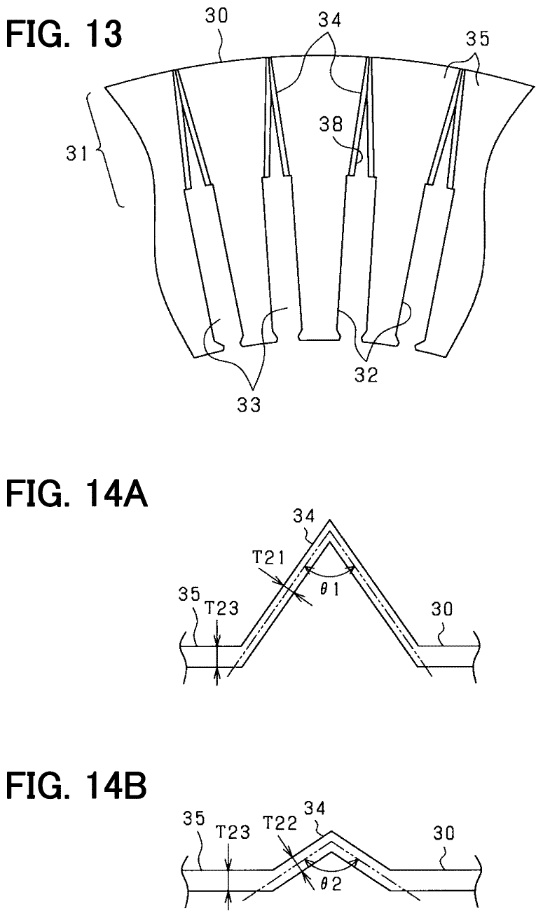

As shown in FIG. 12, at least one core sheet 30 that serves as the axial end of the stator core 11 may be configured with at least a portion including a tip cut out at the convex portion 34. In this case, the convex portion 34 of the core sheet 30, which is the axial end of the stator core 11, should have its top cut off along a line perpendicular to the axial direction. In the stator core 11, the core sheet 30 with the top of the convex portion 34 cut off at the axial end should be laminated, and the core sheet 30 without the top of the convex portion 34 cut off except at the axial end. FIG. 13 shows the core sheet 30 used at the axial end of the stator core 11. In this core sheet 30, a difference from the core sheet 30 (see FIG. 4), except at the axial end, is that the top of the convex portion 34 is cut away to form a notch 38.

According to the stator core 11 of FIGS. 12, 13, an axial length of the stator core 11 is shortened by partial excision of the convex portion 34, thus increasing an amount of core substance without increasing the axial length of the stator core 11. This increases the magnetic path width and improves the torque output.

### Third Modification

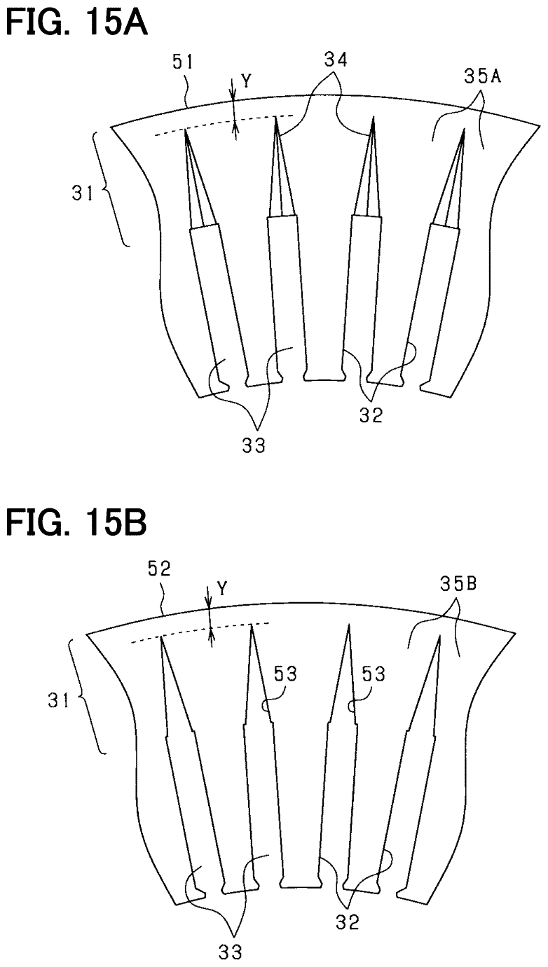

In a core sheet 30, an angle of a triangular apex of a convex portion 34 may be configured to differ between the radially inner and radially outer sides of a yoke forming portion 31. FIGS. 14A, 14B show that shapes in the convex portions 34 differs between the inside and outside of the radial direction in the convex portion 34 of the core sheet 30. FIG. 14A shows an inner shape of the convex portion 34 in the radial direction, and FIG. 14B shows an outer shape of the convex portion 34 in the radial direction.

As shown in FIGS. 14A, 14B, projecting heights of the convex portions 34 are different from each other, as are angles of the triangle apexes. In this case, the angle at the top of the triangle inside the radial direction is “θ1” and the angle at the top of the triangle outside the radial direction is “θ2”, and the relationship between θ1 and θ2 is θ1<θ2. The plate thicknesses of the convex portions 34 are different between the inner and outer radial directions. In this case, a plate thickness of the convex portion 34 inside the radial direction is “T21” and a plate thickness of the convex portion 34 outside the radial direction is “T22”, and a relationship between T21 and T22 is T21<T22. The plate thickness of the flat portion 35 is the same (T23) both inside and outside the radial direction.

In the convex portion 34 of the core sheet 30, the angle of the top of the triangle is different between the inner and outer circumferential sides of the yoke forming portion 31 (back yoke 21) in the radial direction, which allows the circumferential length of the yoke forming portion 31 to be different between the inner and outer circumferential sides of the yoke forming portion 31, making it possible to form a curve of the yoke forming portion 31. In the convex portion 34, the angle of the triangular apex is larger on the outer side of the yoke forming portion 31 in the radial direction than on the inner side in the radial direction, and the plate thickness is also larger. This results in a smaller angle of inclination with respect to the flat portion 35 on the outer end portion in the radial direction where the protruding height of the convex portion 34 is smaller, and the increase in thickness in the stator axial direction due to the inclination is smaller. Therefore, degree of thinning of the steel sheet material can be reduced on the outside of the radial direction, where the size of the bend becomes smaller, and the steel sheet material can be thinned appropriately.

### Second Embodiment

In the present embodiment, a configuration for differing a plate thickness between a convex portion 34 and a flat portion 35 in a core sheet 30 is different from the first embodiment. Here, the core sheet 30 is composed of a first sheet 51 and a second sheet 52, each of which is made of steel sheet material and of different shapes, and by overlapping the first sheet 51 and the second sheet 52, the plate thickness of the convex portion 34 is smaller than that of the flat portion 35.

FIG. 15A is a plan view of the first sheet 51 and FIG. 15B is a plan view of the second sheet 52. As shown in FIG. 15A, the first sheet 51 has a yoke forming portion 31 and teeth forming portions 32, with a slot recess 33 between each of the teeth forming portions 32. A teeth forming portion 32 of the teeth forming portions is provided with convex portions 34 lined up at predetermined intervals in the circumferential direction, and a space between each convex portion 34 is a flat portion 35A. The convex portion 34 is located radially outside of the slot recess 33. In the yoke forming portion 31 of the first sheet 51, the convex portion 34 and the flat portion 35A are continuously provided alternately in the circumferential direction.

On the other hand, as shown in FIG. 15B, the second sheet 52 has a yoke forming portion 31 and teeth forming portions 32, with a slot recess 33 between each teeth forming portion 32. The second sheet 52 differs from the first sheet 51 in that, in the yoke forming portion 31, the outer side of the slot recess 33 in the radial direction is a notch 53 (blank area) without the convex portion 34, and an area between notches 53 in the circumferential direction is a flat portion 35B. In other words, the second sheet 52 is composed of portions of the first sheet 51 excluding the convex portion 34.

In the present embodiment, the first sheet 51 and the second sheet 52 are stacked on top of each other as the core sheet 30, and the core sheet 30 is made of the yoke forming portion 31 and the teeth forming portions 32 of the first sheet 51 and the second sheet 52, respectively, adhered to each other. In this case, the first sheet 51 and the second sheet 52 are superimposed on each other with the yoke forming portion 31 and the teeth forming portion 32 respectively aligned. This allows the convex portion 34 of the first sheet 51 and the notch 53 of the second sheet 52 to be placed in the same position in the core sheet 30.

Here, in the first sheet 51, between an innermost portion in the radial direction and an outermost portion in the radial direction (outer circumferential edge) of the yoke forming portion 31, the flat portion 35A is provided continuously in the circumferential direction in a Y portion on the outer circumferential edge, and the convex portion 34 is provided inwardly in the radial direction from the Y portion. In other words, the first sheet 51 has the convex portion 34 in the yoke forming portion 31 from the innermost position in the radial direction to a middle position in the radial direction. In the second sheet 52, similarly, between the innermost portion in the radial direction and the outermost portion in the radial direction (outer circumferential edge) of the yoke forming portion 31, the flat portion 35B is provided continuously in the circumferential direction in the Y portion on the outer circumferential edge, and the notch 53 is provided inwardly in the radial direction from the Y portion. As a result, in the second sheet 52, portions that become both sides of the convex portion 34 in the circumferential direction when the second sheet 52 is overlapped on the first sheet 51 are continuous on the outer circumferential edge.

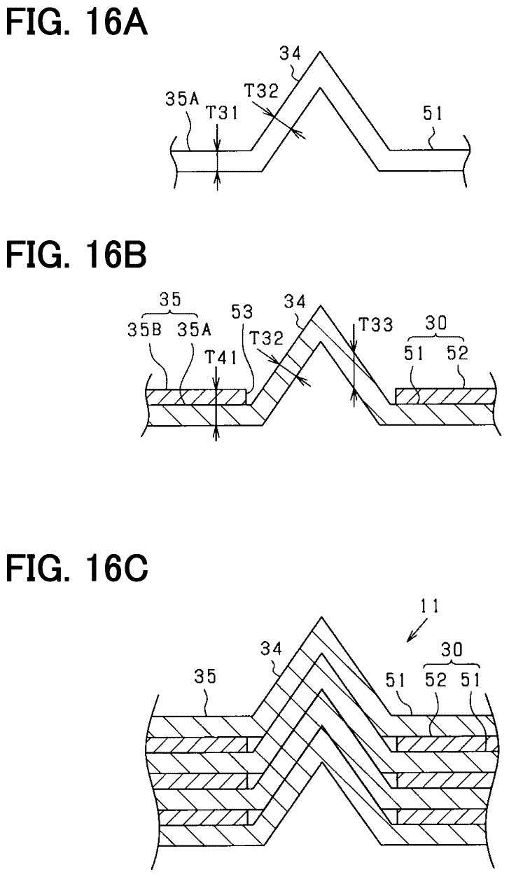

As shown in FIG. 16A, a plate thickness of the flat portion 35A is “T31” and a plate thickness of the convex portion 34 is “T32” in the first sheet 51, and a relationship between T31 and T32 is T31=T32. In other words, the convex portion 34 is formed in the first sheet 51 by bending without any thinning of the steel sheet material.

As shown in FIG. 16B, the first sheet 51 and the second sheet 52 are overlapped with each other, the flat portions 35A, 35B of each sheet 51, 52 are overlapped (i.e., adhered to each other) to form the flat portion 35, and in that state, a plate thickness T41 of the flat portion 35 is larger than the thickness T32 of the convex portion 34. In other words, the plate thickness T32 and T41 are in a relationship T32<T41. The plate thickness T41 of the flat portion 35 should be the same as the thickness T33 in the stacking direction in the convex portion 34. However, T41>T33 is acceptable.

FIG. 16C shows the core sheet 30 consisting of the first sheet 51 and the second sheet 52 laminated in multiple layers. In this state, the convex portions 34 and the flat portions 35 of the core sheet 30 overlap each other in the stacking direction, and no gap is formed between the flat portions 35. As shown in FIG. 16B, the stator core 11 consists of the first sheet 51 in a first layer, which is the axial end face, and the core sheet 30 consisting of the first sheet 51 and the second sheet 52 in the second and subsequent layers. However, it is also possible to have a configuration in which the core sheet 30 consisting of the first sheet 51 and the second sheet 52 is laminated in all layers of the stator core 11 (with the second sheet 52 located on the axial end face).

When manufacturing the stator core 11, the first sheet 51 and the second sheet 52 are prepared, each formed into a flat predetermined shape by pressing, for example, steel sheet material. Each of these sheets 51, 52 is then curved into an arc shape and fed out at the same speed while being stacked on top of each other to make the core sheet 30, and the cylindrical stator core 11 is made by stacking multiple layers of the core sheets 30. In this case, the first sheet 51 is curved into an abbreviated arc shape while the convex portion 34 is bent and formed on the yoke forming portion 31 using a bending device. In the present embodiment, the convex portion 34 is bent and formed without the steel sheet material being thinned by the press-rolling process. On the other hand, the second sheet 52 is curved with the same curvature as the first sheet 51, without being folded and molded. The respective curved and formed first and second sheets 51 and 52 are then stacked on top of each other, and in that state they are laminated into a multilayer. As a result, the stator core is produced in a cylindrical shape.

Here, the second sheet 52 is continuous in the circumferential direction at a portion that is outside the radial direction in the yoke forming portion 31 (the Y portion in FIG. 15). Therefore, the second sheet 52 is fed together with the first sheet 51 without interruption, and the first sheet 51 and the second sheet 52 are suitably stacked on top of each other.

Both the first sheet 51 and the second sheet 52 have flat portions 35A, 35B circumferentially connected outside the radial direction of the yoke forming portion 31. Therefore, even in a configuration in which bending forming is performed on the first sheet 51 and not on the second sheet 52, a circumferential pitch of the teeth forming portions 32 and the slot recess 33 in each of the first sheet 51 and the second sheet 52 can be reduced.

According to the present embodiment, the following effects can be obtained.

The core sheet 30 is composed of the first sheet 51 having the convex portion 34 and continuous in the circumferential direction, and the second sheet 52 comprising a portion of the first sheet 51 excluding the convex portion 34. In this case, the overlap of the first sheet 51 and the second sheet 52 allows the plate thickness of the flat portion 35 to be relatively increased without reducing the thickness of the convex portion 34. Therefore, it is easy to achieve a configuration in which the plate thickness of the convex portion 34 is smaller than that of the flat portion 35.

In the first sheet 51, the plate thickness of the convex portion 34 and the plate thickness of a portion other than the convex portion (the flat portion 35A) are the same, and in the core sheet 30, the plate thickness of the convex portion 34 is smaller than that of the flat portion 35 when the second sheet 52 is overlapped on the first sheet 51. In this case, even if the plate thicknesses are the same for the convex portion 34 and the flat portion 35A in the first sheet 51, in other words, even without thinning the steel sheet material, it is easy to achieve a configuration in which the plate thickness of the convex portion 34 is smaller than that of the flat portion 35 in the core sheet 30.

In the first sheet 51, a portion of the convex portion 34 in the radial direction is from the innermost edge of the yoke forming portion 31 in the radial direction to a middle position in the radial direction, thereby configuring the second sheet 52 in which portions that are the circumferential edges of the convex portion 34 in the yoke forming portion 31 are continuous at the outermost edge in the radial direction. This allows both the first sheet 51 and the second sheet 52 to be continuous in the longitudinal direction, and allows a work of overlapping these respective sheets 51, 52 with each other to be suitably performed.

### Other Embodiments

It is also possible to modify the above described embodiment as follows, for example.

In the above second embodiment, the plate thickness T31 of the flat portion 35A and the plate thickness T32 of the convex portion 34 are the same in the first sheet 51 (see FIG. 16A), but this may be changed. For example, the plate thickness T32 of the convex portion 34 may be smaller than the plate thickness T31 of the flat portion 35A in the first sheet 51. In this case, the first sheet 51 should be made of steel sheet material that is bent and thinned to form the convex portion 34. In the first sheet 51, the convex portion 34 may be configured to be thinner due to stretching caused by a bending of the steel sheet material. In any case, the core sheet 30 should have a plate thickness T32 of the convex portion 34 smaller than the plate thickness T41 of the flat portion 35 when the first sheet 51 and the second sheet 52 are overlapped.

In the above second embodiment, both the first sheet 51 and the second sheet 52 have a configuration in which the flat portions 35A, 35B are circumferentially connected outside the radial direction of the yoke forming portion 31 (see FIGS. 15A, 15B), but this may be changed. For example, in the first sheet 51, the convex portion 34 is provided in a range from the innermost side of the yoke forming portion 31 in the radial direction to the outermost side of the yoke forming portion 31 in the radial direction (i.e., the entire radial direction of the yoke forming portion 31). In this case, the second sheet 52 is divided by the convex portion 34 of the first sheet 51, and is overlapped on each side of the circumferential direction of the convex portion 34 with respect to the first sheet 51.

In each of the above embodiments, the convex portion 34 is provided for each slot recess 33 in the core sheet 30, but this may be changed. For example, the core sheet 30 may be configured with a convex portion 34 for each of the N (“N” is a natural number greater than or equal to 2) slot recesses 33 lined up in the circumferential direction. Alternatively, the core sheet 30 may be configured with a plurality of convex portions 34 for each slot recess 33.

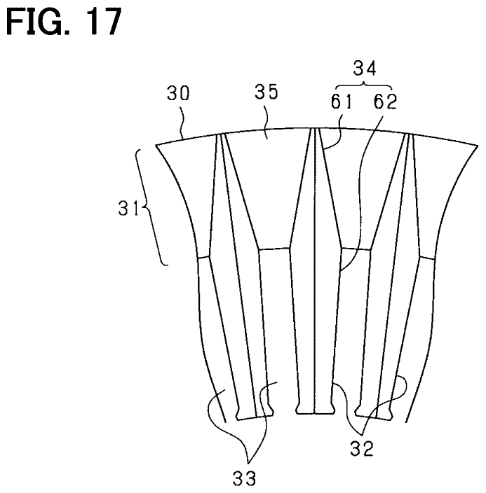

In each of the above embodiments, the yoke forming portion 31 of the core sheet 30 is configured with the convex portion 34 on the outer side of the slot recess 33 in the radial direction, but this may be changed. For example, as shown in FIG. 17, a core sheet 30 is configured with convex portions 34 extending in the radial direction to be continuous at the yoke forming portion 31 and the teeth forming portion 32. In this configuration, in the core sheet 30, a yoke convex portion 61 is provided in the yoke forming portion 31 and a teeth convex portion 62 is provided in the teeth forming portion 32 as the convex portion 34. The yoke convex portion 61 and the teeth convex portion 62 are continuous in the radial direction. A space between the circumferentially adjacent yoke convex portions 61, that is, the radially outer side of the slot recess 33, is the flat portion 35. In such a configuration, as above, plate thicknesses of the convex portions 61, 62 and the flat portion 35 should be different, and the plate thicknesses of the convex portions 61, 62 should be smaller than that of the flat portion 35.

In each of the above embodiments, the stator core 11 has a helical core structure in which the core sheets 30 are spirally stacked, but this may be changed. For example, a stator core 11 may be made by preparing a number of core sheets 30 that form a circular ring and stacking the core sheets 30. In this case, each core sheet 30 in the stacking direction should be circularly curved and shaped by the convex portion 34.

The stator cores may be used in outer-rotor type rotary electric machines in addition to those used in inner-rotor type rotary electric machines. In a case of the stator core used in the outer rotor type rotary electric machine, teeth are provided so that they protrude radially outward from the cylindrical back yoke.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A stator core for a rotary electric machine, comprising
a stator core having a circular back yoke and teeth protruding from the back yoke in a radial direction of the stator core, wherein
the stator core is formed by stacking core sheets in multiple layers,
the core sheet has convex portions provided at predetermined intervals in a circumferential direction, and flat portions provided between adjacent convex portions in the circumferential direction,
each of the convex portions has a folded shape that is convex in a stacking direction and extends in the radial direction,
the convex portions are stacked and overlapping each other in the stacking direction, and
a plate thickness of the convex portion is smaller than a plate thickness of the flat portion.

2. The stator core for the rotary electric machine according to claim 1, wherein
thicknesses of steel sheet material forming the core sheet are different between the convex portions and the flat portions,
a protrusion height of the convex portion on an inner side in the radial direction is larger than a protrusion height of the convex portion on an outer side in the radial direction, and
the convex portion protrudes from the flat portion at a radially outermost position of the back yoke.

3. The stator core for the rotary electric machine according to claim 2, wherein
a concave surface portion on an opposite side of a convex surface portion of the convex portion is an inner convex portion, and
a depth of the inner convex portion at a portion which is an outermost edge in the radial direction is equal to or larger than the plate thickness of the flat portion.

4. The stator core for the rotary electric machine according to claim 2, wherein
the convex portion has a triangular shape,
an angle of an apex of an inner portion of the convex portion in a radial direction of the back yoke is larger than an angle of an apex of an outer portion of the convex portion in the radial direction, and
a plate thickness of the outer portion is larger than a plate thickness of the inner portion.

5. The stator core for the rotary electric machine according to claim 1, wherein
the core sheet includes a first sheet having the convex portions and being continuous in the circumferential direction, and a second sheet having a portion of the first sheet excluding the convex portions,
the first sheet and the second sheet are overlapped with each other in the stacking direction, and
a plate thickness of the convex portion is smaller than a plate thickness of the flat portion.

6. The stator core for the rotary electric machine according to claim 5, wherein
the plate thickness of the convex portion is equal to the plate thickness of a part of the first sheet other than the convex portions, and
the plate thickness of the convex portion is smaller than the plate thickness of the flat portion.

7. The stator core for the rotary electric machine according to claim 5, wherein
the convex portions of the first sheet are provided in a range from an innermost edge in the radial direction to an intermediate position in the radial direction of the back yoke, and
portions which are both sides of the convex portions in the circumferential direction of the second sheet are continuous at the outermost edge in the radial direction.

8. The stator core for the rotary electric machine according to claim 1, wherein
the teeth of the stator core protrude inward from the back yoke in the radial direction of the stator core, and
the convex portion has a flat shape at a top in a predetermined range in the radial direction including an innermost edge in the radial direction.

9. The stator core for the rotary electric machine according to claim 1, wherein
an end portion of at least one layer of the core sheets in the axial direction has a cut out portion in at least a top of the convex portion.

10. The stator core for the rotary electric machine according to claim 1, wherein
the core sheet has a yoke forming portion forming the back yoke and a teeth forming portion forming the teeth,
a rolled portion is provided at an edge of the yoke forming portion in the radial direction opposite to the teeth forming portion, and
a portion between the convex portions in the circumferential direction has a circular arc shape by the rolling portion in a plan view.

11. The stator core for the rotary electric machine according to claim 1, wherein
the core sheet has a yoke forming portion forming the back yoke and a teeth forming portion forming the teeth,
a rolled portion is provided at an edge of the yoke forming portion in the radial direction opposite to the teeth forming portion,
the rolled portion is provided at the edge excluding the convex portions, and
a portion between the convex portions in the circumferential direction has a circular arc shape by the rolling portion in a plan view.
